(19) United States
(12) Patent Application Publication
(10) Pub. No.: US 2007/0216851 A1
(43) Pub. Date: Sep. 20, 2007

(54) Liquid crystal lens and imaging lens device

(75) Inventor: Kenji Matsumoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CITIZEN WATCH CO., LTD.

(21) Appl. No.: 11/711,725

(22) Filed: Feb. 28, 2007

(30) Foreign Application Priority Data
Mar. 1, 2006 (JP) 2006-054668
Sep. 6, 2006 (JP) 2006-241180

(51) Int. Cl. G02F 1/13

(52) U.S. Cl. 349/200

(57) ABSTRACT

The present invention provides an imaging lens device, which has a widely extended focusing range and exhibits good resolution over the entire focusing range. The imaging lens device comprises a liquid crystal lens for focusing an object at a prescribed distance, comprising a liquid crystal layer, a first transparent substrate disposed adjacent to one surface of the liquid crystal layer and having a first electrode and having Fresnel lens surface formed on the boundary with the liquid crystal layer, a second transparent substrate disposed adjacent to the other surface of the liquid crystal layer and having a second electrode; a controller for changing the refractive index of the liquid crystal layer for extraordinary ray by changing electric voltage applied between the first electrode and the second electrode; and an imaging element for taking an image of the object. The liquid crystal lens functions as a diffractive optical element for an extraordinary ray when the liquid crystal layer has a prescribed refractive index for an extraordinary ray incident upon the liquid crystal layer.

### CROSS REFERENCE TO RELATED APPLICATIONS

The Applicant claims the right of priority based on Japanese Patent Application JP 2006-54668, filed on Mar. 1, 2006, and Japanese Patent Application JP 2006-241180, filed on Sep. 6, 2006, and the entire contents of JP 2006-54668 and JP 2006-241180 are hereby incorporated by reference.

### FIELD OF THE INVENTION

The present invention relates to a liquid crystal lens and an imaging lens device, and more particularly to an imaging lens device using a liquid crystal lens as a variable focus lens.

### BACKGROUND OF THE INVENTION

Recently, a mobile phone handset equipped with a digital camera (hereinafter referred to as a mobile camera phone) has become more and more prevalent. From the viewpoint of mobility, it is desirable to have a mobile phone that is of small size and light weight, as well as of low profile. Therefore, it is required that an imaging lens device mounted on a mobile camera phone also be small and light weight, as well as short. Also, a solid state image sensor mounted on a camera such as a CCD image sensor, a CMOS sensor, etc., is required to have an increasingly larger number of pixels, and an imaging element having several millions of pixels has now been made available. As the number of pixels of a solid state image sensor has increased, pixel size has become smaller. Thus, an imaging lens device that uses such a solid state image sensor as a detector is required to have higher resolution. In addition, higher performance in proper camera functions is also required for a camera module that is provided in a mobile camera phone. For example, a camera module that is provided in a mobile phone is required to have an auto-focus function by means of a variable focusing mechanism, or a function of image-pickup at the closest distance to an object (i.e. a macro mode photography function).

Conventionally, in order to achieve these functions, a drive mechanism comprising a stepping motor, a voice coil motor or the like, has been provided in the camera module. At the time of focusing, or at the time of macro mode photography, the drive mechanism is used to move the entire optical system or a part of the lenses included in the optical system thereby changing the conjugate relationship between the object plane and the image plane and bringing the camera module into focus. In the prior art, however, there is a problem that the size of the camera module becomes larger due to the provision of the drive mechanism in the camera module. In addition, power consumption increases due to the large power consumed by the drive mechanism for driving the lenses. Further, lens performance of the optical system may be degraded due to an aberration produced in the optical system by the tilting the lenses or a deviation of the optical axis of the lenses in the movement of the lenses.

In order to resolve these problems, a focusing mechanism has been proposed in which the focal length of the imaging lens is changed by using a lens having variable lens power as represented by a liquid crystal lens (see for example, Patent Reference 1). The focusing mechanism disclosed in Patent Reference 1 comprises a liquid crystal lens having two transparent substrates, a liquid crystal layer sandwiched between these transparent substrates, and a zonal electrode provided on at least one of these transparent substrates. The focusing mechanism can change the refractive index distribution in the liquid crystal layer by varying the distribution of the electric voltage applied to the liquid crystal layer using the zonal electrode. A liquid crystal lens has been also proposed, which comprises two transparent substrates, a liquid crystal layer sandwiched between these transparent substrates, and an electrode provided on at least one of these transparent substrates, wherein one of the transparent substrates is constructed as a curved surface (see for example, Patent Reference 2). In the liquid crystal lens disclosed in Patent Reference 2, the lens power of the liquid crystal lens can be changed by changing the electric voltage applied to the liquid crystal layer.

Patent Reference 1: Japanese Patent No. 3047082 (pages 1 to 4, FIGS. 1 to 3)

Patent Reference 2: Japanese Patent Publication No. 2001-272646 (page 1, FIGS. 1 to 3)

### SUMMARY OF THE INVENTION

However, with the focusing mechanism as disclosed in Patent Reference 1, it is difficult to produce a smooth distribution of refractive index in the liquid crystal layer since the zonal electrode has non-uniform structure. In addition, the zonal electrode itself gives rise to diffraction and scattering of the light incident upon the liquid crystal lens, which also lead to degradation of the lens performance of the liquid crystal lens.

Further, when the focusing function is to be realized by using the method as disclosed in the above-mentioned Patent Reference 1 or 2, it is required to increase the maximum lens power of the liquid crystal lens and to increase the variable range of the lens power of the liquid crystal lens in order to obtain a sufficiently wide focusing range so as to be able to accommodate macro mode photography or the like. In order to do this, the thickness of the liquid crystal layer of the liquid crystal lens has to be increased. However, as the liquid crystal layer is thick, the response performance of the liquid crystal lens decreases and the manufacture of the liquid crystal lens becomes more difficult.

Therefore, application of a conventional liquid crystal lens has been limited to an auto-focus function. On the other hand, a liquid crystal lens has an optical path length comparable to other fixed lenses. Thus, when a liquid crystal lens is to be employed in a camera module for a mobile phone for which a low profile is required, the optical path length becomes too large for a camera module of low profile. In addition, the maximum lens power of a liquid crystal lens cannot be adequately increased, and therefore, focusing range is limited.

Also, an imaging lens is usually designed such that the optimum aberration of the imaging lens is obtained when the object plane and the image plane is in certain conjugate relationship with each other. Thus, if the lens power of a liquid crystal lens included in the imaging lens is changed for focusing, an aberration such as an astigmatism, curvature of field, etc. becomes large, leading to a degraded resolution of the imaging lens.

Conventionally, color aberration of an imaging lens is corrected by a combination of refractive lenses. For this purpose, it is required to compose an imaging lens from a plurality of lenses formed of lens material of different dispersion characteristics, with a part of the plurality of lenses being a concave lens with negative lens power. Therefore, it is difficult to shorten the optical path length of the imaging lens, and it is also difficult to decrease the cost of an imaging lens.

Thus, it can be envisaged to form at least one of the transparent substrates of a liquid crystal lens in the shape of a Fresnel lens so as to treat a liquid crystal lens as a diffractive optical element. In this case, the diffractive optical element has an inverse dispersion characteristics as compared to a refractive lens that can be utilized for correction of color aberration. However, the range of the lens power of a liquid crystal lens, which allows color aberration to be reduced is limited to the range in which phase matching is possible, and color aberration cannot be reduced over the entire focusing range.

It is an object of the present invention to provide an imaging lens device having an auto-focus function with no moving parts.

It is another object of the present invention to provide an imaging lens device, which allows the aberration to be corrected satisfactorily over the entire focusing range.

It is still another object of the present invention to provide an imaging lens device having an auto-focus function, as well as a macro mode photography function.

It is still another object of the present invention to provide an imaging lens device of small size having an auto-focus function with excellent response performance with no moving parts.

The imaging lens device according to the present invention employs the basic construction as described below.

The imaging lens device according to the present invention comprises a liquid crystal lens for focusing an object at a prescribed object distance, the liquid crystal lens comprising a first liquid crystal layer, a first transparent substrate disposed adjacent to one surface of the first liquid crystal layer and having a first electrode and a Fresnel lens surface formed at the boundary surface with the first liquid crystal layer, a second transparent substrate disposed adjacent to the other surface of the first liquid crystal layer and having a second electrode, the liquid crystal lens functioning as a diffractive optical element to the extraordinary ray when the first liquid crystal layer has a prescribed refractive index for the extraordinary ray incident upon the first liquid crystal layer, a controller, which changes the refractive index of the first liquid crystal layer for the extraordinary ray by changing the electric voltage applied between the first electrode and the second electrode, and an imaging element for taking a photographic image of the object.

In accordance with the present invention, since the lens power of a liquid crystal lens can be adjusted by changing the refractive index of the liquid crystal layer of the liquid crystal lens, the imaging lens device can focus an image of an object on the image plane of the imaging element without moving a part or all of the imaging lens system or without moving the imaging element even if the object distance varies from infinity to the closest distance. Thus, there is provided an imaging lens device that is small in size and excellent in the responsive characteristics at the time of focusing. If the refractive index of the first liquid crystal layer for the extraordinary rays has the prescribed value, the liquid crystal lens functions as a diffractive optical element so that good correction of aberration, especially color aberration, can be achieved by the entire imaging lens device as a whole. Therefore, the focusing range can be extended with small variation of aberration associated with the change of the object distance, and an imaging lens device having a macro mode photography function can be thereby provided. The term “extraordinary ray”, as used in this specification, refers to the polarization component of light rays incident upon the liquid crystal layer for which the refractive index of the liquid crystal layer changes in association with the change of the long axis direction of the liquid crystal molecules contained in the liquid crystal later. “Ordinary ray” refers to the polarization component of light rays incident upon the liquid crystal layer, which is orthogonal to the extraordinary ray.

Further, steps are formed on the Fresnel lens surface so as to divide the Fresnel lens surface into a plurality of regions, and it is preferable that the optical path difference produced at the step for the extraordinary ray incident upon the first liquid crystal layer is an integer multiple of the wavelength at which the imaging element is sensitive when the refractive index of the first liquid crystal layer for the extraordinary ray has the prescribed value. By determining the amount of step difference formed on the Fresnel lens surface in this manner, the liquid crystal lens can function as a diffractive optical element at the desired wavelength.

The prescribed value of the refractive index of the first liquid layer for the extraordinary ray is preferably the minimum value of the refractive index included in the variable range of the refractive index of the first liquid crystal layer for the extraordinary ray. By setting the variable range of the refractive index in this manner, the optical path difference produced at the step difference formed on the Fresnel lens surface always becomes greater than one wavelength for the light having wavelength to be detected by the imaging element. Thus, especially when the incident light is white light, for which coherent length is short, the degradation of the lens performance, due to interference of light rays passing through adjacent regions of the Fresnel lens surface that would be produced if the refractive index of the liquid crystal layer for the extraordinary ray were set otherwise than the above-described prescribed value, can be suppressed.

Further, it is preferable that the refractive index of the first transparent substrate coincides with the refractive index of the first liquid crystal layer for the ordinary ray. If the refractive index of the first transparent substrate coincides with the refractive index of the first liquid crystal layer for the ordinary ray, the liquid crystal lens has no lens power for the ordinary ray so that lens design is simplified.

Alternatively, the liquid crystal lens is preferably able to function as a diffractive optical element also for ordinary ray incident upon the first liquid crystal layer. In this case, since the liquid crystal lens functions as a diffractive optical element for both polarization components, correction of aberration of the lens system including the liquid crystal lens can be thereby simplified. Further, it is preferable that the Fresnel lens surface is an aspherical surface.

Further, the second transparent substrate of the liquid crystal lens preferably has a Fresnel lens surface formed on the boundary interface with the first liquid crystal layer. When the liquid crystal lens functions as a diffractive optical element, degradation of diffraction efficiency that depends upon the wavelength or angle of incidence of the incident light can be reduced.

Further, in the imaging lens device according to the present invention, it is preferable that the liquid crystal lens comprises a second liquid crystal layer, a third transparent substrate disposed adjacent to one surface of the second liquid crystal layer and having a Fresnel lens surface formed on the boundary interface with the second liquid crystal layer, and a fourth transparent substrate disposed adjacent to the other surface of the second liquid crystal layer, wherein the liquid crystal in the first liquid crystal layer and the liquid crystal in the second liquid crystal layer are oriented such that respective long molecular axes are perpendicular to each other, and when the second liquid crystal layer has a prescribed refractive index for the extraordinary ray incident upon the second liquid crystal layer, the second liquid crystal layer functions as a diffractive optical element for the extraordinary ray.

By stacking two liquid crystal layers with the orientation directions of the respective liquid crystals perpendicular to each other and forming Fresnel lens surfaces on the boundary interfaces of respective liquid crystal layers, it is possible to change the lens power of the liquid crystal lens for all the polarization components of the incident light ray by changing the refractive index of respective liquid crystal layers. When the first liquid crystal layer and the second liquid crystal layer have the prescribed refractive indices, the liquid crystal lens functions as a diffractive optical element for all the polarization components, so that good correction of the aberration, especially color aberration, can be achieved.

Further, it is preferable that the Fresnel lens surface of the first transparent substrate and the Fresnel lens surface of the third transparent substrate respectively have the shape of a cylindrical lens, and are arranged such that the functional directions as the Fresnel lens are perpendicular to each other.

The liquid crystal lens exhibits the same lens effect as in the case where the Fresnel lens surface is formed as a pattern of concentric circles, while the possibility of occurrence of defects such as line breakage at the time of forming electrodes on the Fresnel lens surface can be reduced.

Another imaging lens device according to the present invention comprises a liquid crystal lens for focusing an object at a prescribed object distance, the liquid crystal lens comprising a first liquid crystal layer, a first transparent substrate disposed adjacent to one surface of the first liquid crystal layer and having a first electrode and having a Fresnel lens surface formed on the boundary surface between a first electrode and the first liquid crystal layer, and a second transparent substrate disposed adjacent to the other surface of the first liquid crystal layer and having a second electrode, the liquid crystal lens functioning as a diffractive optical element for the ordinary ray incident upon the first liquid crystal layer, a controller which can change the refractive index of the first liquid crystal layer for the extraordinary ray by changing the electric voltage applied between the first electrode and the second electrode, and an imaging element for taking a photographic image of the object.

For ordinary ray incident upon the first liquid crystal layer, the liquid crystal lens functions as a diffractive optical element and performs correction of the aberration of the lens system, whereas for extraordinary ray incident upon the first liquid crystal layer, the liquid crystal lens can function as a Fresnel lens having a variable lens power. Thus, variation of aberration associated with variation of object distance can be reduced even when the focusing range is increased so that an imaging lens device having macro-mode photography function can be provided.

It is preferable that steps are also formed on the Fresnel lens surface for dividing the Fresnel lens surface into a plurality of regions, and the optical path difference produced at the step for the ordinary ray incident upon the first liquid crystal layer is an integer multiple of the wavelength to which the imaging element is sensitive. By determining the amount of step difference formed on the Fresnel lens surface in this manner, the liquid crystal lens can function as a diffractive optical element at the desired wavelength.

Further, in the imaging lens device according to the present invention, the optical path difference produced at the step for the ordinary ray incident upon the first liquid crystal layer is preferably one or two times above-described wavelengths. It is preferable that the controller changes the refractive index of the first liquid crystal layer for the extraordinary ray such that the minimum value of the optical path difference produced at the first step for the extraordinary ray incident upon the first liquid crystal layer is greater than the coherence length of the extraordinary ray. By setting the variable range of the refractive index in this manner, the liquid crystal lens can prevent interference of light rays passing through adjacent regions of the Fresnel lens surface for the extraordinary ray incident upon the first liquid crystal layer. Therefore, degradation of lens performance due to the occurrence of the interference can be suppressed. The upper boundary of the variable range of the refractive index of the first liquid crystal layer for the extraordinary ray can be selected arbitrarily in accordance with the specification of the imaging lens device.

Further, the second transparent substrate preferably has a Fresnel lens surface formed on the boundary surface with the first liquid crystal layer.

Further, it is preferable that the liquid crystal lens comprises a second liquid crystal layer, a third transparent substrate disposed adjacent to one surface of the second liquid crystal layer and having a Fresnel lens surface formed on the boundary surface with the second liquid crystal layer, and a fourth transparent substrate disposed adjacent to the other surface of the second liquid crystal layer, wherein the liquid crystal in the first liquid crystal layer and the liquid crystal in the second liquid crystal layer are oriented such that respective long axis direction is orthogonal to each other, and wherein the second liquid crystal layer functions as a diffractive optical element for the ordinary ray incident upon the second liquid crystal layer.

With such a construction, when an electric field of the same driving waveform is applied to both the first and second liquid crystal layers, the first Fresnel lens surface functions as a diffractive optical element to achieve the aberration correction and the second Fresnel lens surface functions as a lens having variable lens power, for one of the mutually orthogonal polarization components, while, for the other polarization component, the first Fresnel lens surface functions as a lens having variable lens power and the second Fresnel lens surface functions as a diffractive optical element to achieve the aberration correction. Thus, the liquid crystal lens can achieve good aberration correction to all the polarization components, and at the same time, can change the lens power so as to obtain good focusing.

Further, it is preferable that the Fresnel lens surface of the first transparent substrate and the Fresnel lens surface of the third transparent substrate respectively have the shape of a cylindrical lens, and are arranged such that the functional directions as the Fresnel lens are orthogonal to each other.

When the liquid crystal lens functions as a diffractive optical element, it is preferable that the lens has a positive power. A diffractive optical element generally has an inverse dispersion characteristics as compared to a common refractive lens. Thus, when a liquid crystal lens that functions as a diffractive optical element has a positive lens power, the color aberration of a refractive lens having the similar positive lens power is cancelled so that the color aberration of the lens system including the liquid crystal lens can be advantageously corrected.

In the liquid crystal lens used in the imaging lens device according to the present invention, it is preferable that the first transparent substrate has a member with a Fresnel lens surface formed thereon. The first transparent substrate further comprises a flat plate-shaped substrate, and the first electrode is preferably disposed between the flat plate-shaped substrate and the member. By disposing the electrode between the flat plate-shaped substrate and the member having a Fresnel lens surface formed thereon, the electrode can be formed on a smooth surface so that line breakage and disturbance of orientation due to transverse electric field applied to the liquid crystal near the Fresnel lens surface which may arise when the electrode is formed on the Fresnel lens surface can be prevented.

Alternatively, a Fresnel lens surface may be formed on a portion of the transparent substrate.

A liquid crystal lens according to the present invention comprises a liquid crystal layer, a first transparent substrate disposed adjacent to one surface of the liquid crystal layer and having a Fresnel lens surface formed on the boundary surface with the liquid crystal layer, a second transparent substrate disposed adjacent to the other surface of the liquid crystal layer, and a first electrode and a second electrode for changing the electric voltage applied to the liquid crystal layer so as to change the refractive index for extraordinary ray incident upon the liquid crystal layer, and the liquid crystal lens functions as a diffractive optical element for the extraordinary ray when the liquid crystal layer has a prescribed refractive index for the extraordinary ray incident upon the liquid crystal layer.

Another liquid crystal lens according to the present invention comprises a liquid crystal layer, a first transparent substrate disposed adjacent to one surface of the liquid crystal layer and having a Fresnel lens surface formed on the boundary surface with the liquid crystal layer, a second transparent substrate disposed adjacent to the other surface of the liquid crystal layer, and a first electrode and a second electrode for changing the electric voltage applied to the liquid crystal layer so as to change the refractive index for extraordinary ray incident upon the liquid crystal layer, and the liquid crystal lens functions as a diffractive optical element for ordinary ray incident upon the liquid crystal layer.

In accordance with the present invention, there is provided an imaging lens device which can achieve an auto-focus function with no moving parts, can prevent degradation of lens performance of the imaging lens due to a variation of aberration, etc., at the time of auto-focusing, and exhibits high resolution over the entire focusing range.

Also, in accordance with the present invention, there is provided an imaging lens device capable of taking a photograph in macro mode.

Further, in accordance with the present invention, there is provided an imaging lens device which is of small size and excellent in response performance and which has auto-focus function with no moving parts.

### DESCRIPTION OF THE DRAWINGS

These and other features and advantages of the present invention will be better understood by reading the following description taken together with the drawings wherein:

FIG. 1 is a sectional view showing an imaging lens device according to a first embodiment of the present invention;

FIG. 2 is a sectional view and a front view showing an example of liquid crystal lens that composes an imaging lens device according to the present invention;

FIG. 3 is a view useful for explaining the sectional shape of the Fresnel lens surface of the liquid crystal lens according to the present invention;

FIG. 4 (a) is a graph showing MTF obtained by the imaging lens device according to the first embodiment of the present invention with an infinite object distance, and FIG. 4 (b) is a graph showing MTF obtained by the imaging lens device according to the first embodiment of the present invention with the object distance of 100 mm;

FIG. 5 is a sectional view showing an imaging lens device according to a second embodiment of the present invention;

FIG. 6 (a) is a graph showing MTF obtained by the imaging lens device according to the second embodiment of the present invention with the object distance of 100 mm, and FIG. 6 (b) is a graph showing MTF obtained by the imaging lens device according to the second embodiment of the present invention with an infinite object distance;

FIG. 7 is a schematic sectional view showing the construction of another example of the liquid crystal lens according to the present invention;

FIG. 8 is a sectional view of a diffraction grating useful for explaining the diffraction efficiency of a laminate type diffractive optical element according to the present invention;

FIG. 9 is a graph showing variation of diffraction efficiency of a laminate type diffractive optical element according to the present invention;

FIG. 10 (a) is a view useful for explaining means for forming a Fresnel lens surface of a liquid crystal lens according to the present invention, and FIG. 10 (b) is a view useful for explaining the positional relationship between the electrode and the Fresnel lens surface; and

FIG. 11 is a schematic plan view and schematic sectional view showing another example of a liquid crystal lens according to the present invention.

### DETAILED DESCRIPTION OF THE PREFERRED EMBODIMENT

Now the present invention will be described in detail with reference to the appended drawings showing an imaging lens device according to preferred embodiments thereof. The present invention is not restricted by the following description and covers the invention and its equivalent as described in the claims.

An imaging lens device according to the present invention includes a liquid crystal lens having variable lens power for focusing. The liquid crystal lens comprises two transparent substrates and a liquid crystal layer sandwiched between the transparent substrates, and a Fresnel lens surface having a plurality of circular zones is formed on the surface of the transparent substrate in contact with the liquid crystal layer. By forming the step between respective circular zones of the Fresnel lens such that the optical path difference produced at the step is an integer multiple of prescribed wavelength, the liquid crystal lens can function as a diffractive optical element and can be utilized in correction of aberration, especially correction of color aberration.

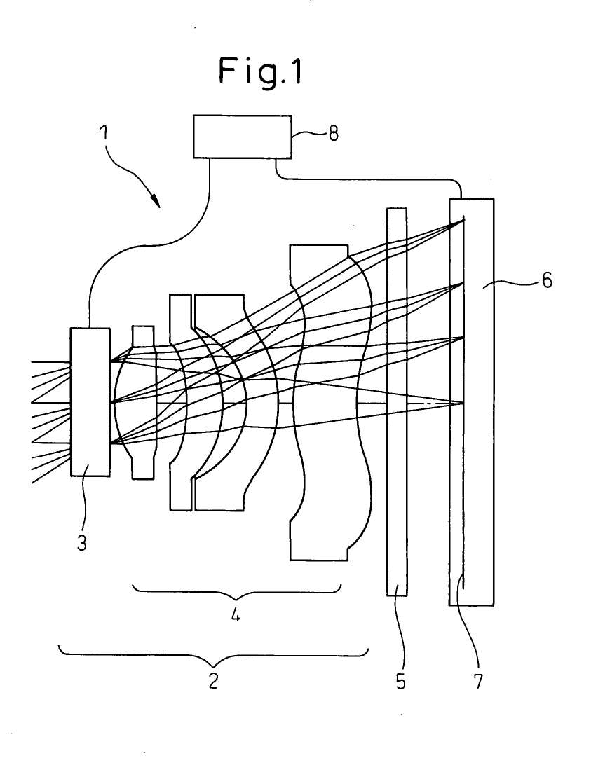

First, an imaging lens device according to a first embodiment of the present invention will be described. FIG. 1 is a sectional view showing the imaging lens device according to the first embodiment of the present invention.

As shown in FIG. 1, the imaging lens device 1 is composed of a lens system 2 comprising a liquid crystal lens 3 and an optical lens group 4 consisting of a plurality of optical lenses, an Ir filter 5 and an imaging element 6. Luminous flux emitted from an object is incident upon the liquid crystal lens 3 situated at the nearest side to the object. The incident light is transmitted through the liquid crystal lens 3, the optical lens group 4, the Ir filter 5 in this order, and forms an image on the imaging plane 7 of the imaging element 6 . Although, in this embodiment, the optical lens group 4 is composed of four optical lenses, the number of lenses is not limited to four. The position of the liquid crystal lens 3 is not limited to the front side of the optical lens group 4, but may be at the rear side of the optical lens group 4. Alternatively, the liquid crystal lens 3 may be disposed at an intermediate position between lenses included in the optical lens group 4. The Ir filter 5 is inserted in the imaging lens device 1 in order to cut off the infra-red radiation and to reduce degradation of image quality due to an imaging element sensitive to infra-red radiation. Thus, when it is intended to detect infra-red radiation by the imaging lens device 1, the Ir filter 5 may be omitted.

The liquid crystal lens 3 is connected to a controller 8. The controller 8 comprises a central processing unit (CPU), memories such as RAM, ROM and associated electronic circuits, and softwares ran on CPU. The controller 8 drives the liquid crystal lens 3 by controlling electric voltage applied to the liquid crystal lens 3 based on the auto-focus signal obtained from the images taken by the imaging element 6, etc., and changes lens power of the liquid crystal lens 3. The controller 8 may be incorporated into the imaging lens device 1. Alternatively, it may be composed of a microprocessor or the like provided independently from the imaging lens device 1.

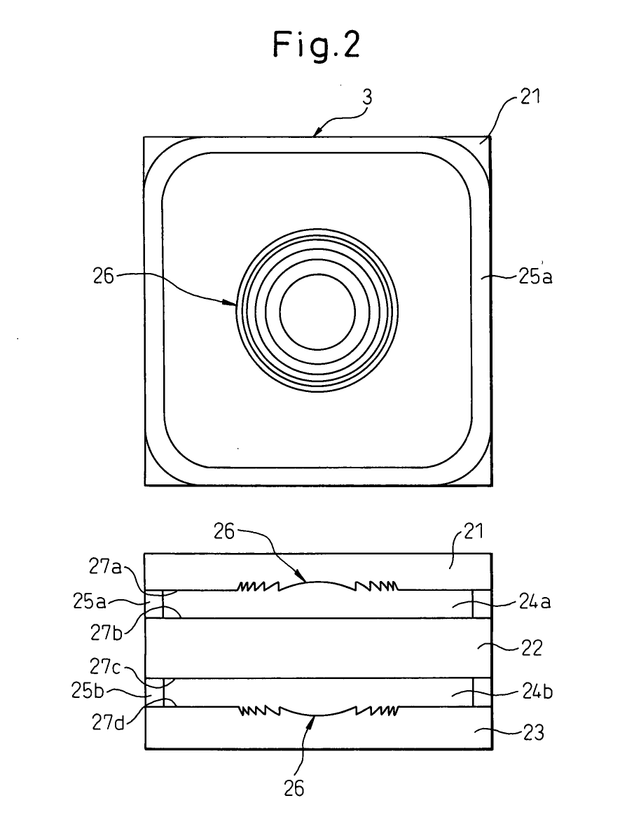

Next, the liquid crystal lens 3 will be described in detail with reference to FIG. 2. FIG. 2 is a schematic front view and sectional view showing a liquid crystal lens 3.

As shown in FIG. 2, the liquid crystal lens 3 comprises, for example, three opposing transparent substrates 21, 22, 23. Electrodes 27a˜27d are formed, respectively, consisting of transparent electro-conductive film, on the lower surface of the transparent substrate 21 disposed on the upper side, that is, on the side of an object, on the upper and lower surfaces of the transparent substrate 22 disposed in the center, and on the upper surface of the transparent substrate 23 disposed on the lower side, that is, on the side of the optical lens group 4.

The lower surface of the transparent substrate 21 and the upper surface of the transparent substrate 23 are formed as Fresnel lens surfaces. Continuous surface between steps formed on the Fresnel lens surface may be simple spherical surface, but in view of reduction of aberration, is preferably formed as aspherical surface. The Fresnel lens surface 26 may be formed on any surface in contact with the liquid crystal layers 24a, 24b, and may be provided, for example, on the upper and the lower surface of the transparent substrate 22.

As the method for forming a Fresnel lens surface on the transparent substrate 21, 23, it is preferred in view of mass production that transparent resin be formed in prescribed shape by injection molding. The method for forming a Fresnel lens surface is not limited to this method, and various other methods such as machine processing, imprint processing, etc., may be employed.

Between the transparent substrate 21 and 22, and between the transparent substrates 22 and 23, there is a liquid crystal, for example, a liquid crystal of homogeneous orientation, sealed so as to constitute liquid crystal layers 24a, 24b, respectively. Thus, the liquid crystal lens 3 is composed of an upper liquid crystal panel consisting of the transparent substrates 21, 22, and a liquid crystal layer 24a sandwiched therebetween, and a lower liquid crystal panel consisting of the transparent substrates 22, 23, and a liquid crystal layer 24b sandwiched therebetween. Here, the transparent substrate 22 of each liquid crystal panel is common to these panels. However, for simplicity of fabrication, etc., a liquid crystal lens may be composed using two transparent substrates for the upper liquid crystal panel and the lower liquid crystal panel, respectively, in place of one common transparent substrate 22.

The direction of the orientation of the liquid crystal sealed in the upper liquid crystal panel is orthogonal to direction of the orientation of the liquid crystal sealed in the lower liquid crystal panel. That is, the directions of the long axis of the liquid crystal molecule contained in respective liquid crystal panels are orthogonal to each other. When the direction of the long axis of the liquid crystal molecules of homogeneous orientation is changed to a direction perpendicular to the substrate by application of electric voltage to the electrodes, the refractive index of the liquid crystal layer for the polarization component parallel to the long axis of the liquid crystal molecules (that is, an extraordinary ray) is changed. With such a construction, in the upper liquid crystal panel, phase modulation is performed on the polarization component parallel to the long axis of liquid crystal molecule, and in the lower liquid crystal panel, phase modulation is performed on the polarization component orthogonal to the polarization component subjected to phase modulation in the upper liquid crystal panel. As a result, the liquid crystal lens 3 can achieve phase modulation, that is, lens effect, on all the polarization components. The orientation of the liquid crystal used in the liquid crystal lens is not limited to the homogeneous orientation, and various other orientations such as a homeotropic orientation, twist nematic orientation, etc., may be used.

The controller 8 drives the upper liquid crystal panel (that is, the liquid crystal panel composed of the transparent substrates 21, 22 and the liquid crystal layer 24a) and the lower liquid crystal panel (that is, the liquid crystal panel composed of the transparent substrates 22, 23 and the liquid crystal layer 24b) with a driving electric voltage of the same waveform. The driving electric voltage is an alternating electric voltage, for example, a pulse height modulated (PHM) or pulse width modulated (PWM) alternating electric voltage.

43 As shown in FIG. 2, seals 25a, 25b are provided on the periphery of the liquid crystal layers 24a, 24b, respectively, between the transparent substrates 21˜23. The seals 25a, 25b include spacers (not shown), and prevent leakage of the liquid crystal and keep the thickness of each crystal layer 24a, 24b constant.

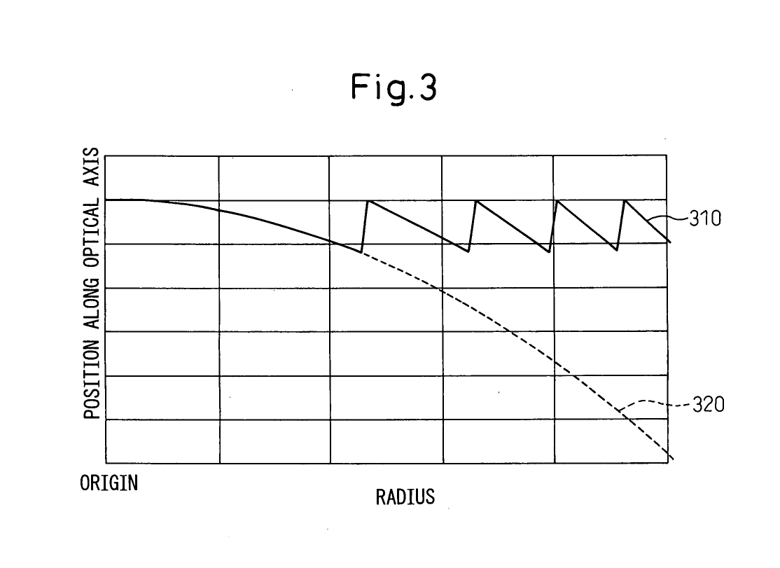

44 Next, the structure of the Fresnel lens surface of the above-described liquid crystal lens 3 will be described in detail below. FIG. 3 shows the cross section view of the Fresnel lens surface taken along radial direction with the vertex of the lens surface (that is, the point of the lens surface lying on the optical axis) taken as the origin. In FIG. 3, the horizontal axis of the graph represents the position along radial direction, and the vertical axis of the graph represents the position along the direction of optical axis.

As shown by dotted line 320 in FIG. 3, the Fresnel lens surface of the liquid crystal lens 3 is initially designed, like other optical lenses, as a continuous curved surface that is centro-symmetric about the optical axis. On the continuous curved surface, as one departs from the optical axis in radial direction, the distance between the lens surface and the vertex in the direction of optical axis increases. Therefore, when this distance amounts to a prescribed value, a step is provided on the lens surface such that the position of the lens surface along the optical axis becomes same as the vertex. By similarly providing a step on the lens surface when the distance between the lens surface and the vertex in the direction of optical axis amounts to a prescribed value, the cross sectional shape as shown by the solid line 310 in FIG. 3 is obtained. A Fresnel lens surface having a plurality of circular zones bounded by the steps is thus formed. Although, in this case, the magnitude of the step difference at each boundary of circular zones is a constant, this needs not necessarily be the same. As an example, the continuous curved surface represented by the dotted line may be aspherical shape as represented by the equation (1) below. In general, a lens surface having an aspherical shape is able to correct aberration more efficiently than a lens surface having a spherical shape.

If steps are removed from the Fresnel lens surface so as to form a continuous curved surface, it is represented, for example, by the following equation (1)

$$z = \frac{{cr}^{2}}{1 + \sqrt{1 - ( K + 1 ) {c}^{2} {r}^{2}}} + {Qr}^{2} + {Ar}^{3} + {Br}^{4} + {Cr}^{5} + {Dr}^{6} + {Er}^{7} + {Fr}^{8} + {Gr}^{9} + {Hr}^{10} \\ {r}^{2} = {x}^{2} + {y}^{2} \qquad ( 1 )$$

where z represents the distance along the optical axis from the vertex of the lens surface (z takes positive value on the image side of the vertex), r represents the distance from the optical axis, and c represents the curvature of the curve. K represents the conic coefficient, and Q, and each coefficient A˜H, are constants. Here, terms which directly pertain to an auto-focus function, that is, terms which influence lens power, are those containing r², that is, the first term and the second term in the right hand side of the equation (1). By suitably setting coefficients B, D, F, and H of other terms such as r⁴, r⁶, r⁸ and r¹⁰, the aberration of the lens system 2 can be corrected satisfactorily.

By setting the step difference such that the optical path difference (actual step difference x difference of refractive index between the two media having the lens surface as the boundary) is an integer multiple of the wavelength of the incident light, the function as a diffractive optical element can be imparted to the Fresnel lens surface. Since a diffractive optical element has negative dispersion characteristics that is inverse to a refractive lens, color aberration can be cancelled and reduced by suitable combination of the two types of lenses, that is, a diffractive lens and a refractive lens. Since the lens system 2 has a positive overall lens power, when the liquid lens 3 has a positive lens power as a diffractive lens, color aberration produced in the lens group 4 and the color aberration produced in the liquid lens 3 can be cancelled with each other, and color aberration of the lens system 2 can be effectively corrected.

However, since, in the liquid crystal lens 3, refractive index of the liquid crystal layer 24a, 24b changes, the phase matching at the step is satisfied only when the lens power of the liquid crystal lens 3 is at a certain level. Here, “phase matching condition” in the present invention means the condition in which the optical path difference produced at the step provided on the Fresnel lens surface is an integer multiple of the wavelength incident upon the Fresnel lens. In the case where white light is used as in an imaging lens device, since the incident light is not a luminous flux with uniform phase as in laser light, it is preferable that the optical path difference at each step of the discontinuity of the Fresnel lens surface is one wavelength.

When phase matching is satisfied at a certain lens power, the wave front from various zones may be brought out-of-phase by changing lens power of the liquid crystal lens 3. In particular, when the lens power of the liquid crystal lens 3 is set to half the lens power at which phase matching is satisfied, the luminous flux from various zones interfere with each other so that adverse effect of the phase mismatch becomes the greatest, and the resolution of the lens system 2 of the imaging lens device 1 is degraded. But, the light involved in imaging is white light which has intrinsically low coherence and for which coherent length is short. Therefore, it is possible to decrease the effect of phase mismatch by setting the range of utilized lens power such that the lens power in the case of phase matching is the minimum value of the range, that is, by setting the range of utilized lens power such that the optical path difference at each step is larger than that in the case of phase matching. Alternatively, instead of making the optical path difference at each step equal to one wavelength, by setting it equal to two or more integer multiple of the wavelength, the phase difference between the luminous flux emitted from various zones can-be increased and adverse effect of phase mismatching can be thereby decreased.

The liquid crystal lens 3 preferably satisfies the phase matching condition at some wavelengths included in the wavelength domain in which an image is to be detected by the imaging element 6, that is, at some wavelengths at which the imaging element 6 has sensitivity. For example, the liquid crystal lens 3 preferably satisfies phase matching condition at a wavelength for which the imaging element 6 has the highest sensitivity, or at the wavelength corresponding to the center of gravity of the sensitivity for each wavelength. When the wavelength distribution of the incident light is known, the liquid crystal lens 3 may satisfy the phase matching condition at the center wavelength or at the center-of-gravity wavelength of the incident light.

Lens design data of a lens design based on the above-described principle are shown in Table 1 and Table 2. Table 1 shows paraxial design data of the liquid crystal lens 3 and the optical lens group 4. Among the values in Table 1, “radius of curvature” and “surface distance” are shown in unit of millimeter (mm). “Surface distance” represents distance between lens surfaces on the optical axis. Table 2 shows aspherical coefficients of each lens surface. Values of the coefficients G and H are 0 for each surface. As shown in FIG. 1, the lens system 2 is an optical system consisting of the liquid crystal lens 3 on the nearest side to the object, followed by the 4 optical lens group 4, and the Ir filter 5 and imaging surface 7 arranged in this order.

TABLE 1

| | radius of | surface | refractive | Abbe |
|---|---|---|---|---|
| | curvature | distance | index | number |
| liquid crystal lens | Infinity | 0.2300 | 1.52 | 62 |
| liquid crystal layer 1 | Infinity | 0.0200 | variable | |
| | Infinity | 0.3000 | 1.52 | 62 |
| liquid crystal layer 2 | Infinity | 0.0200 | variable | |
| | Infinity | 0.2300 | 1.52 | 62 |
| | Infinity | 0.0700 | | |
| lens 1 | 1.5754 | 0.7047 | 1.4847 | 70 |
| | −4.3587 | 0.1000 | | |
| lens 2 | −4.3975 | 0.5000 | 1.5247 | 56.2 |
| | −4.4230 | 0.4181 | | |
| lens 3 | −0.4630 | 1.0145 | 1.8355 | 23.7 |
| | 10.5575 | 0.1247 | | |
| lens 4 | 0.7093 | 1.0664 | 1.5247 | 56.2 |
| | 1.7753 | 0.5000 | | |
| Ir filter | Infinity | 0.3000 | 1.518 | 58.9 |
| | Infinity | 0.7000 | | |
| image plane | Infinity | 0.0000 | | |

TABLE 2

| | | aspherical coefficients | | | | | | | |
|---|---|---|---|---|---|---|---|---|---|
| | | K | Q | A | B | C | D | E | F |
| lens 1 | surface 1 | −2.2075 | 0.0000 | 0.0375 | −0.2057 | 0.9296 | −1.7006 | 1.6111 | −0.6141 |
| | surface 2 | 0.1676 | 0.0000 | 0.0150 | 0.1177 | −0.0391 | 0.0906 | 0.0108 | −0.0650 |
| lens 2 | surface 1 | −999.0000 | 0.0000 | −0.3940 | 1.0849 | −1.5368 | 1.5631 | −0.5165 | −0.5406 |
| | surface 2 | −1.0000 | 0.0000 | −0.1732 | 0.9139 | −2.1092 | 1.7717 | 1.0056 | −3.2851 |
| lens 3 | surface 1 | −0.8698 | 0.6377 | 0.1686 | −1.6157 | 8.7982 | −25.5619 | 43.4909 | −43.8398 |
| | surface 2 | −280.3819 | 0.0067 | −0.4293 | 0.1999 | 0.1639 | −0.4120 | 0.4051 | −0.2654 |
| lens 4 | surface 1 | −0.9348 | 0.0000 | −0.9936 | 1.1005 | −1.1417 | 0.9451 | −0.7110 | 0.4059 |
| | surface 2 | −782.7110 | 0.0000 | 0.3176 | −0.0892 | −0.4389 | 0.5918 | −0.3916 | 0.1514 |

The Fresnel lens surface constituting the liquid crystal lens 3 has an aspherical surface as represented by the equation (1) shown above in order to obtain good correction for various aberrations such as spherical aberration, coma aberration, astigmatism, etc. That is, the Fresnel lens surface is aspherical in order to reduce the change of aberration at the time of auto-focusing. On the Fresnel lens surface on the side of the object (the surface of the liquid crystal layer 1 on the object side), coefficients in the equation (1) are, respectively, Q=0.0267, B=0.0133, D=−0.0190, and A=C=E=F=G=H=0. On the other hand, on the Fresnel lens surface on the side of the image (the surface of the liquid crystal layer 2 on the image side), coefficients in the equation (1) are, respectively, Q=−0.0267, B=−0.0133, D=0.0190, and A=C=E=F=G=H=0.

When, for extraordinary ray, the difference of refractive index between the substrates 21˜23 and the liquid crystal layers 24a, 24b is minimum, step difference between zones is set such that each Fresnel lens surface satisfies the phase matching condition at the design wavelength. In this embodiment, the design wavelength is that of d line (wavelength of 587 nm). The minimum value of the refractive index of the liquid crystal layers 24a, 24b for ordinary ray and the refractive index for extraordinary ray is 1.58, the step difference between zones is 9.8 μm in design. Thus, for aspherical surface represented by equation (1) and the coefficients as described above, step is provided for the value of z equal to 9.8 μm or −9.8 μm.

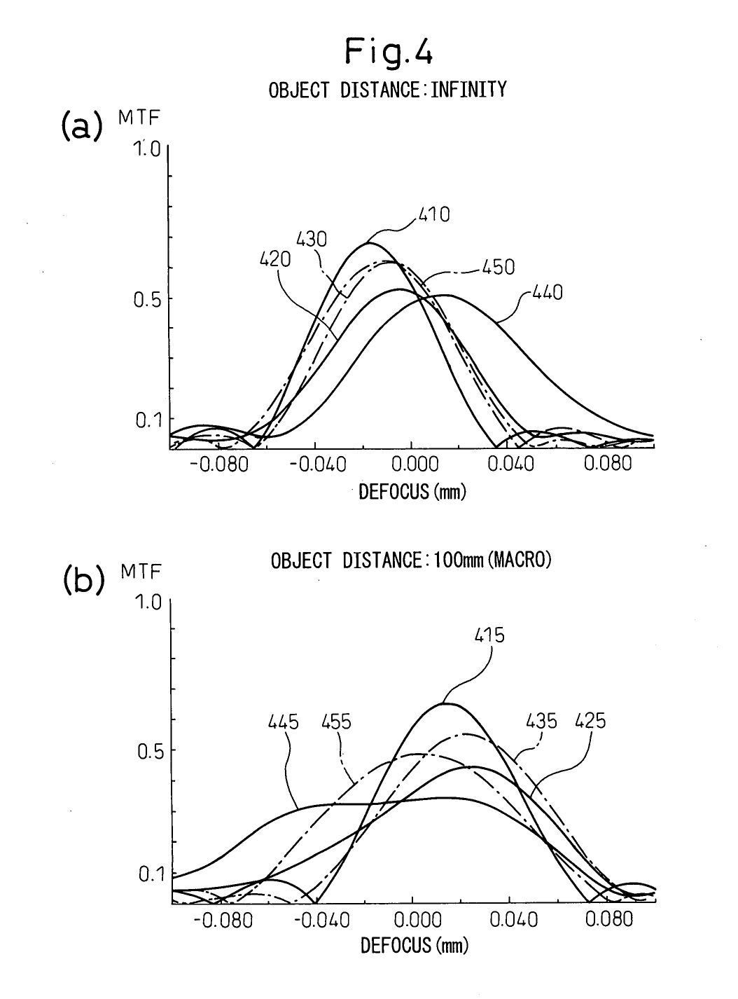

The result of simulation for focusing performed by using the optical system constructed with the lens data shown in Table 1 and Table 2 and varying the refractive index of the liquid crystal layer 24a, 24b, will be described. In this simulation, the refractive index of the liquid crystal layer 24a, 24b for extraordinary ray was varied from 1.58 to 1.72. That is, the difference between the refractive index of the transparent 21˜23 (1.52) and the refractive index of the liquid crystal layer 24a, 24b for extraordinary ray was varied from 0.06 to 0.2. The object distance corresponding to this variation of the refractive index is from infinity to 100 mm. The result of simulation of MTF (Modulation Transform Function) is shown in FIG. 4(a) and FIG. 4(b). MTF shown here is a measure of lens performance generally in wide use, and represents the extent of contrast transfer when an image of a repetitive pattern with a certain spatial frequency is formed by an imaging lens. As the MTF is high, the resolution of the lens is high. FIG. 4(a) and FIG. 4(b) show the result of simulation of MTF for the imaging lens 1 in the present embodiment at spatial frequency of 100 lp/mm for refractive index of the liquid crystal layers 24a, 24b of 1.58 (object distance of infinity) and 1.72 (object distance of 100 mm), respectively. In FIG. 4(a) and FIG. 4(b), the horizontal axis represents the defocus position (mm) and the vertical axis represents MTF (%). The defocus position refers to the position in the direction of the optical axis, and with the position of paraxial optical image point taken as 0, represents the displacement before and behind the image point. The graph 410 shown in FIG. 4(a) illustrates MTF for luminous flux with angle of view of 0°. The graph 420 in solid line and the graph 430 in dashed dotted line illustrate MTFs in the meridional direction and in the sagittal direction, respectively, for luminous flux with the angle of view of 40% the maximum angle of view (33°). Similarly, the graph 440 in solid line and the graph 450 in dashed dotted line illustrate MTFs in the meridional direction and in the sagittal direction, respectively, for luminous flux with the angle of view of 70% the maximum angle of view (33°).

Similarly, the graph 415 shown in FIG. 4(b) illustrates MTF for luminous flux of the angle of view of 0°. The solid line in graph 425 and the dashed dotted line in graph 435 illustrate MTFs in the meridional direction and in the sagittal direction, respectively, for luminous flux with the angle of view of 40% the maximum angle of view (33°). Similarly, the solid line in graph 445 and the dashed dotted line in graph 455 in illustrate MTFs in the meridional direction and in the sagittal direction, respectively, for luminous flux with the angle of view of 70% the maximum angle of view (33°).

As shown in FIG. 4(a) and FIG. 4(b), the position of the peak of MTF for each angle of view is approximately the same, and it can be seen that, even when the lens power of the liquid crystal lens 3 is varied so as to change the object distance for focusing from the closest distance to infinity, variation of the position of the peak of MTF for each angle of view is small and good focusing is achieved.

As described above, in accordance with the first embodiment of the present invention, the step difference between zones of the Fresnel lens surface 26 provided on the boundary of the liquid crystal layers 24a, 24b and the transparent substrates 21, 23 of the liquid crystal lens 3 of variable lens power used in focusing, is set such that, at generally minimum lens power (that is, generally minimum refractive index of the liquid crystal layer 24a, 24b for extraordinary ray) of the liquid crystal lens 3, the difference of the optical path length at the step is an integer multiple of the wavelength of incident light, especially an integer multiple of any of the wavelength for which the imaging element has sensitivity. With such a construction, it is also possible to impart the function of a diffractive optical element to the liquid crystal lens 3, while the interference of luminous flux from zones of the Fresnel lens surface 26 can be prevented even when the lens power of the liquid crystal lens 3 is changed. As a result, the imaging lens device 1 can exhibit excellent image-forming performance over the entire focusing range.

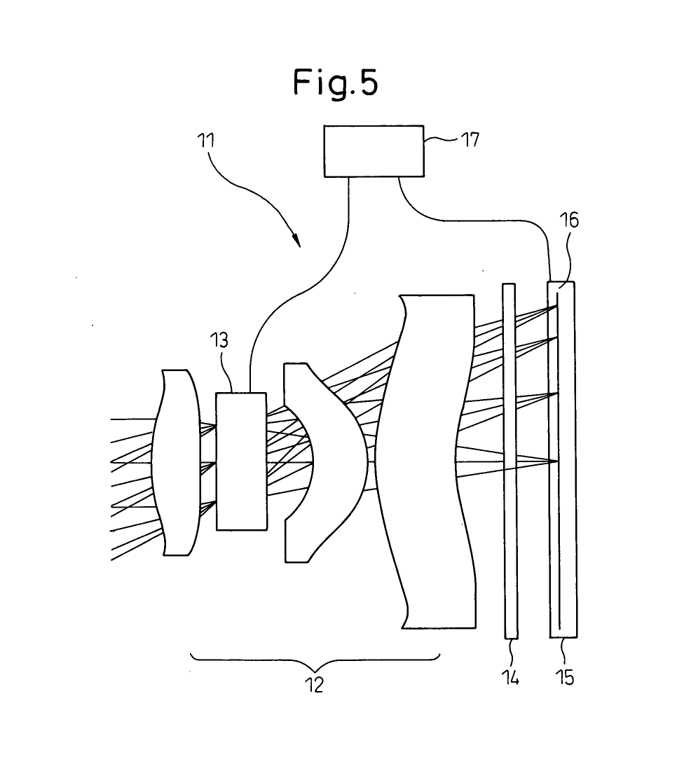

Next, an imaging lens device according to a second embodiment of the present invention will be described. FIG. 5 shows an imaging lens device according to a second embodiment of the present invention in sectional view.

As shown in FIG. 5, the imaging lens device 11 comprises a lens system 12 consisting of a liquid crystal lens 13 and a plurality of optical lenses, an Ir filter 14 and an imaging element 15. The luminous flux emitted from an objectis transmitted through the lens system 12, and the Ir filter 14, and forms an image on the image surface 16 of the imaging device 15. The difference between the first embodiment and the second embodiment lies in the scheme of setting the useful range of the lens power of the liquid crystal lens 13, the construction of the lens system 12, and positional relationship between the lens system 12 and the liquid crystal lens 13. First, the scheme of setting the useful range of the lens power of the liquid crystal lens 13 will be described in detail below. The structure of the liquid crystal lens 13 is same as the structure of the liquid crystal lens 3, except for the shape of the Fresnel lens surface (width of zones, curved shape of zones, step difference). Therefore, the structure of the liquid crystal lens 13 will be described with reference to FIG. 2. The lens system 2 and the shape of Fresnel lens surface of the liquid crystal lens 13 will be described later. As in the first embodiment, the liquid crystal lens 13 is connected to a controller 17. The controller 17 drives the liquid crystal lens 13 by controlling the electric voltage applied to the liquid crystal lens 13 based on the auto-focus signal obtained from an image formed by the imaging element 15 or the like, and thereby changes the lens power of the liquid crystal lens 13. Like the controller 8 in the previous embodiment, the controller 17 also has a central processing unit (CPU), memory such as RAM, ROM, and associated electronic circuits, and software run on a CPU. The controller 17 may be incorporated in the imaging lens device 11, or it may be composed of a microprocessor or the like provided independently from the imaging lens device.

As described above, it is possible to impart the function as a diffractive optical element to the Fresnel lens surface by setting the step difference such that the optical path difference (actual step difference x difference of refractive index between the two media having the lens surface as the boundary) is an integer multiple of the wavelength of the incident light. Since a diffractive optical element has negative dispersion characteristics that is inverse to a refractive lens, color aberration can be corrected efficiently by combining two kinds of lenses, that is, a diffractive lens and a refractive lens.

However, since the refractive index of the liquid crystal layer 24a or 24b of the liquid crystal lens 13 for extraordinary ray changes, the phase matching condition at the step of the Fresnel lens surface 26 is satisfied only when the lens power of the liquid crystal lens 13 takes a specific value. If the lens power of the liquid crystal lens 13 has a value other than the specific value, the liquid crystal lens 13 cannot function as a diffractive optical element, and functions only as a Fresnel lens. Therefore, by changing the electric voltage applied to the liquid crystal lens 13, the imaging lens device 11 can adjust the focal position. However, when the phase matching condition is not satisfied, the liquid crystal lens 13 does not function as a diffractive optical element, and as a result, the liquid crystal lens 13 does not exhibit an aberration correction effect over entire focusing range. Especially, an adverse effect of phase mismatch is the highest when the wave fronts from various zones are completely out-of-phase, and may deteriorate the resolution of the lens.

On the other hand, for an ordinary ray, the refractive index of the liquid crystal layer 24a and 24b of the liquid crystal lens 13 does not change, and it is possible to satisfy the phase matching condition over the entire focusing range. Therefore, the present embodiment is constructed such that the liquid crystal lens 13 functions as a diffractive optical element for correcting aberration for ordinary ray, and functions as a Fresnel lens of variable lens power for auto-focusing for extraordinary ray. Thus, the liquid crystal lens 13 performs aberration correction for one of the polarization components, and the lens power is variable for the other polarization component orthogonal to it. The liquid crystal lens 13 can achieve both aberration correction function and auto-focus function by the change of lens power change. Therefore, by arranging two layers of such functional elements perpendicular to each other, the liquid crystal lens 3 can function as an optical element that has both functions of aberration correction and variable lens power for all the polarization components.

Thus, as shown in FIG. 2, by applying same driving waveform to two liquid crystal layers 24a, 24b which have the long axis of liquid crystal perpendicular to each other, the liquid crystal lens 13 can, for one of the mutually orthogonal polarization components, perform aberration correction with the liquid crystal layer 24a, and at the same time, change the lens power of the liquid crystal layer 24b, while, for the other of the mutually orthogonal polarization components, it can change the lens power of the liquid crystal layer 24a, and at the same time, perform aberration correction with the liquid crystal layer 24b. With such an operative action, for all the polarization components obtained by polarization separation, the liquid crystal lens 3 having liquid crystal layers 24a, 24b can use respectively different layers of the liquid crystal layers 24a, 24b to perform aberration correction and lens power change at the same time.

Table 3 shows the lens design data for the lens system 12. Table 3 shows a paraxial design data for the lens system 12. In the values shown in Table 3, “radius of curvature” and “surface distance” are shown in unit of millimeter (mm). “Surface distance” means distance between lens surfaces on the optical axis. Table 4 shows the aspherical coefficients of each lens surface represented by equation (1). Value of each coefficient not shown in Table 4 is 0. In Table 3, the lens surfaces are described in the order starting from the object side (left side of FIG. 5).

TABLE 3

| | radius of | surface | refractive | Abbe |
|---|---|---|---|---|
| | curvature | distance | index | number |
| lens 1 | 1.9611 | 0.5964 | 1.525 | 56 |
| | −15.8997 | 0.1874 | | |
| liquid crystal lens | Infinity | 0.15 | 1.57 | 62 |
| | Infinity | 0.01 | variable | |
| | Infinity | 0.3 | 1.57 | 62 |
| | Infinity | 0.01 | variable | |
| | Infinity | 0.15 | 1.57 | 62 |
| | Infinity | 0.5712 | | |
| lens 2 | −0.7353 | 0.6537 | 1.525 | 56 |
| | −0.9593 | 0.075 | | |
| lens 3 | 1.7704 | 0.9525 | 1.525 | 56 |
| | 1.7913 | 0.5769 | | |
| IR filter | Infinity | 0.15 | 1.52 | 62 |
| | Infinity | 0.5 | | |
| image plane | Infinity | | | |

TABLE 4

| | | aspherical coefficients | | | | |
|---|---|---|---|---|---|---|
| | | K | B | D | F | H |
| lens 1 | surface 1 | 0.4925 | −0.0396 | −0.0290 | −0.0442 | −0.0073 |
| | surface 2 | 251.7346 | −0.0537 | −0.0734 | 0.0250 | 0.0226 |
| lens 2 | surface 1 | −3.4086 | −0.7641 | 0.5186 | −0.4408 | 0.3698 |
| | surface 2 | −0.3722 | −0.0492 | 0.0731 | −0.007 | 0.0709 |
| lens 3 | surface 1 | −10.5923 | −0.0214 | 0.0079 | 0.0020 | −0.0009 |
| | surface 2 | −5.7118 | −0.0463 | −0.0004 | 0.0042 | −0.0008 |

The Fresnel lens surface constituting the liquid crystal lens 13 is an aspherical surface represented by the above-described equation (1) in order to correct aberrations such as spherical aberration, coma aberration, and astigmatism satisfactorily. That is, the Fresnel lens surface is aspherical surface so as to reduce the change of aberration at the time of auto-focusing. For the Fresnel lens surface on the object side (object side of the liquid crystal layer 1 ), the coefficients in equation (1) are, respectively, Q=−0.732, B=−0.0650, D=0.2155, c=K=A=C=E=F=G=H=0. On the other hand, for the Fresnel lens surface on the image side (image side of the liquid crystal layer 2 ), the coefficients in equation (1) are, respectively, Q=0.0732, B=0.0650, D=−0.2155, c=K=A=C=E=F=G=H=0.

For each Fresnel surface, step difference is set so as to satisfy the phase matching condition at the design wavelength for ordinary ray. Here, the design wavelength is 550 nm , and the step difference is 11 μm . Thus, for the aspherical surface represented by equation (1) and respective coefficients as described above, steps are provided where the value of z is 11 μm or −11 μm . The refractive index of the liquid crystal layers 24a and 24b for ordinary ray is 1.52.

The liquid crystal lens 13 has the color aberration corrected for the polarization component belonging to the ordinary ray, and has the lens power changed for the polarization component belonging to the extraordinary ray.

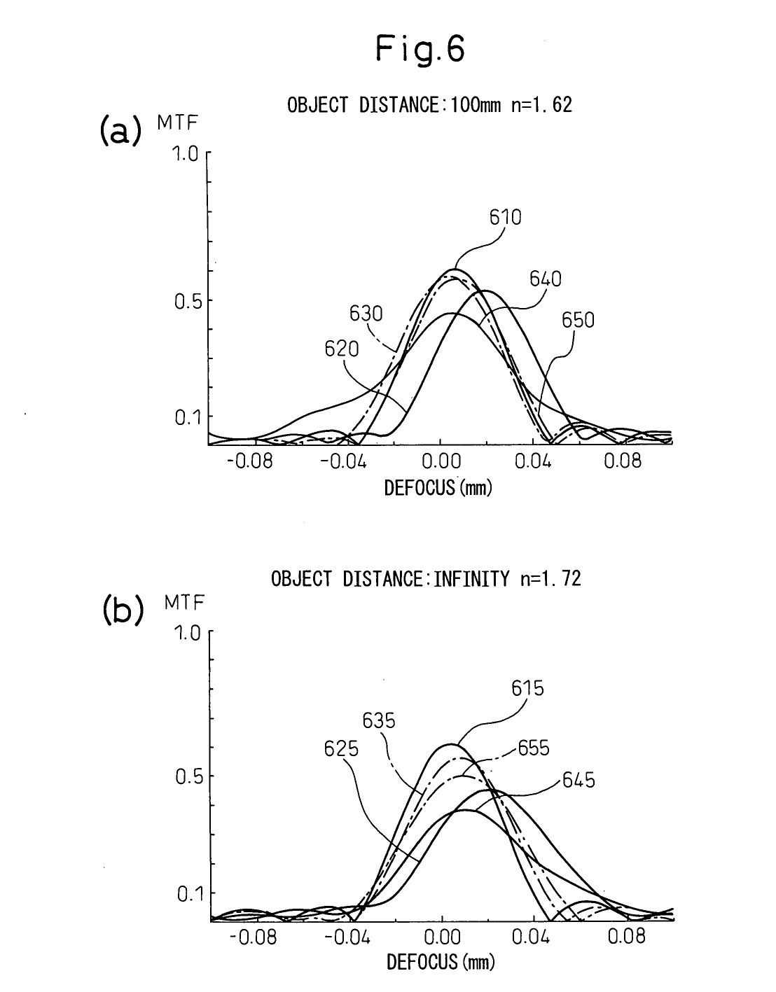

The result of simulation of focusing performed by using the optical system having the data shown in Table 3 and Table 4 and by changing the refractive index of the liquid crystal layers 24a, 24b of the liquid crystal lens 13, will be described below. In this simulation, the refractive index of the liquid crystal layers 24a, 24b of the liquid crystal lens 13 for extraordinary ray was changed from 1.62 to 1.72. Thus, the difference between the refractive index of the transparent substrates 21˜23 (1.57) and the refractive index of the liquid crystal lens 13 for extraordinary ray was changed from 0.05 to 0.15. In this case, since the Fresnel lens surfaces have convex shape relative to the liquid crystal layers 24a, 24b, the Fresnel lens surfaces have negative power. The object distance corresponding to the change of refractive index is from 100 mm to infinity. FIG. 6(a) and FIG. 6(b) show the result of simulation of MTF of the imaging lens device according to the present embodiment for spatial frequency of 140lp/mm for the refractive index of 1.62(object distance of 100 mm) and 1.72(object distance of infinity), respectively. In FIG. 6(a) and FIG. 6(b), the horizontal axis represents the defocus position (mm) and the vertical axis represents MTF (%). The graph 610 shown in FIG. 6(a) illustrates MTF for luminous flux with angle of view of 0°. The graph 620 in solid line and the graph 630 in dashed dotted line illustrate MTFs in the meridional direction and in the sagittal direction, respectively, for luminous flux with the angle of view of 40% the maximum angle of view (33°). Similarly, the graph 640 in solid line and the graph 650 in dashed dotted line illustrate MTFs in the meridional direction and in the sagittal direction, respectively, for luminous flux with the angle of view of 70% the maximum angle of view (33°).

Similarly, the graph 615 shown in FIG. 6(b) illustrates MTF for luminous flux of the angle of view of 0°. The graph 625 in solid line and the graph 635 in dashed dotted line illustrate MTFs in the meridional direction and in the sagittal direction, respectively, for luminous flux with the angle of view of 40% the maximum angle of view (33°). Similarly, the solid line in graph 645 and the dashed dotted line in graph 655 illustrate MTFs in the meridional direction and in the sagittal direction, respectively, for luminous flux with the angle of view of 70% the maximum angle of view (33°).

As shown in FIG. 6(a) and FIG. 6(b), the position of the peak of MTF for each angle of view is approximately the same, and it can be seen that, even when the lens power of the liquid crystal lens 13 is changed so as to focus at the object distance which is changed from the closest distance to infinity, variation of the position of the peak of MTF for each angle of view is small and good focusing is achieved. Also, it can be seen that MTF for the luminous flux for each angle of view has sufficiently high value near the peak of MTF for the luminous flux for the angle of view of 0°, and that aberration is satisfactorily corrected.

As described above, in accordance with the second embodiment of the present invention, the step difference between zones of the Fresnel lens surface 26 provided on the boundary of the liquid crystal layers 24a, 24b and the transparent substrates 21, 23 of the liquid crystal lens 13 of variable lens power used in focusing, is set such that the optical path difference produced at the step for ordinary ray is an integer multiple of design wavelength, preferably one design wavelength, of the incident light. For an extraordinary ray, the refractive index of the liquid crystal layers 24a, 24b is changed within such range that optical path difference produced at the step is greater than the design wavelength of the incident light. With such construction, the liquid crystal lens 13 can also function as a diffractive optical element over the entire range of variable lens power. As a result, the imaging lens device 11 can have a wide focusing range and exhibit good image-forming performance over the entire focusing range.

For the polarization component for which the Fresnel lens surface 26 does not function as a diffractive optical element, that is, for an extraordinary ray for which the refractive index of the liquid crystal layer 24a or 24b is variable, the step provided on the Fresnel lens surface 26 is preferably designed such that the optical path difference produced at the step is sufficiently large as compared to the coherent length for design wavelength in order to suppress degradation of resolution due to interference of diffracted light from different zones as small as possible. For the polarization component for which the Fresnel lens surface 26 functions as a diffractive optical element, that is, for an ordinary ray in the liquid crystal layer 24a or 24b, in order to achieve such a construction while satisfying the phase matching condition, the difference of refractive index between the liquid crystal and the substrate should be small for an ordinary ray, and the difference of refractive index should be large for an extraordinary ray.

It is assumed that, for example, the design wavelength is 500 nm. It is further assumed that the refractive index of the liquid crystal layers 24a, 24b for ordinary ray is 1.5, and can be changed from 1.5 to 1.7 for extraordinary ray. On the other hand, the refractive index of the substrate composing the Fresnel lens surface 26 is assumed to be 1.52. In this case, difference of the refractive index between the substrate and the liquid crystal layers 24a, 24b for ordinary ray is 0.02. Thus, if the step difference provided on the Fresnel lens surface 26 is set to 25 μm, the optical path difference produced at the step for the light of design wavelength of 500 nm is one design wavelength, and phase matching condition is satisfied. Then, the liquid crystal lens 3 functions as a diffractive optical element, and can be utilized to correct aberration of the lens system incorporating the liquid crystal lens 13.

On the other hand, if the range in which the refractive index of the liquid crystal layers 24a, 24b for extraordinary ray is changed and limited to the range from 1.6 to 1.7, the optical path difference produced at the step provided on the Fresnel lens surface 26 is about 4 to 9 times the design wavelength for incident light of a design wavelength of 500 nm. Therefore, if the incident light is white light, the liquid crystal lens 13 does not function as a diffractive optical. element, but functions simply as a lens with variable power. Thus, the liquid crystal lens 3 can be used as a variable focus lens for auto-focusing. If the refractive index of the liquid crystal layers 24a, 24b for extraordinary ray is changed in this manner in a range such that the optical path difference produced at the step on the Fresnel lens surface is larger than the coherent length of the incident light, deterioration of aberration due to phase mismatching within the range of focusing adjustment can be prevented. In this case, the difference of the refractive index between the substrate and the liquid crystal layers 24a, 24b for an extraordinary ray is from 0.08 to 0.18. Therefore, with suitable choice of the curvature of the Fresnel lens surface 26, it is possible to change the lens power of the liquid crystal lens 26 over a wide range. Thus, by changing the lens power of the liquid crystal lens 13, focusing over a sufficiently wide range, for example, an object distance from 100 mm to infinity can be achieved.

Next, the structure of a liquid crystal lens used in an imaging lens device according to another embodiment of the present invention will be described.

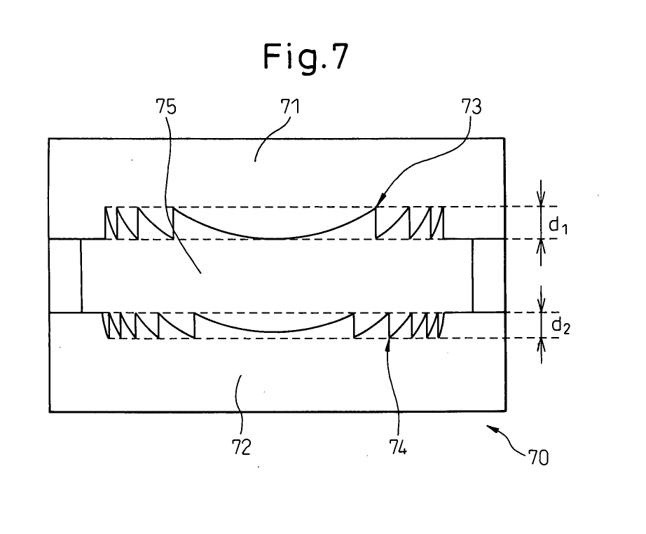

FIG. 7 shows a liquid crystal lens 70 according to this embodiment in a sectional view. The liquid crystal lens 70 has the same structure as the liquid crystal lens 3 according to the first embodiment, that is, the structure in which two liquid crystal layers are stacked in an arrangement with the long axis of the liquid crystal perpendicular to each other. For simplicity, structure of only one layer is depicted in FIG. 7.

The construction of the liquid crystal lens 70 according to the present embodiment differs from the construction of the liquid crystal lens 13 according to the second embodiment in the arrangement of Fresnel lens surface. That is, in the liquid crystal lens 3, Fresnel lens surface 26 is provided only on one of the transparent substrates opposed to each other with the liquid crystal layer sandwiched therebetween. In the liquid crystal lens 70, however, Fresnel lens surfaces 73, 74 are provided on both sides of the transparent substrates 71, 72 opposed to each other with the liquid crystal layer 75 sandwiched therebetween. Since other conditions are the same, detailed explanation thereof is omitted here. In the liquid crystal lens according to the present embodiment as in the liquid crystal lens 3 according to the first or the second embodiment, the width of the step provided on Fresnel lens surface of the liquid crystal lens and useful range of the lens power of the liquid crystal lens can be set. The shape of the Fresnel lens surface 3 and the construction of each optical lens can be suitably modified in accordance with the specification.

Fresnel lens surfaces 73, 74 are provided on the surfaces of the transparent substrates 71, 72 adjoining to the liquid crystal layer 75. The step difference at the discontinuities of Fresnel lens surface 73 provided on the upper transparent substrate 71 is dl, and the step difference at the discontinuities of Fresnel lens surface 74 provided on the lower transparent substrate 72 is d2. Although actual values of thickness of the liquid crystal layer 75 and the step differences at discontinuities of Fresnel lens surface 73, 74 are respectively about 10 μm, they are shown exaggeratedly in FIG. 7 compared to the thickness of the transparent substrate 71, 72 for the sake of simplicity.

As shown in the present embodiment, by stacking Fresnel lens surfaces 73, 74 as a laminate in one liquid crystal panel, degradation of diffraction efficiency, which is a problem with a diffractive optical element, can be avoided. An ideally designed diffractive optical element can exhibit 100% theoretical diffraction efficiency for incident light of a specific wavelength and at specific angle of incidence. For incident light having wavelength other than the specific wavelength and at an angle of incidence other than the specific angle of incidence, diffraction efficiency decreases. Luminous flux other than the desired diffracted light, mainly the O-order light, causes flare and leads to degradation of resolution. By constructing the liquid crystal lens 70 instead of a single-layered Fresnel lens structure, but as a double-layered Fresnel lens structure, a degree of freedom in design is increased, and optical properties such as refractive index, dispersion, etc., of each liquid crystal layer, height of steps and distance between the discontinuities on Fresnel lens surfaces 73, 74, and the like, can be set more flexibly. Therefore, the liquid crystal lens 70 can be designed such that the dispersion characteristics or angle of incidence characteristics of the diffraction efficiency of Fresnel lens surfaces 73 and 74 may cancel each other. Thus, a diffractive optical element having diffraction efficiency independent of wavelength and angle of incidence of incident light can be obtained.

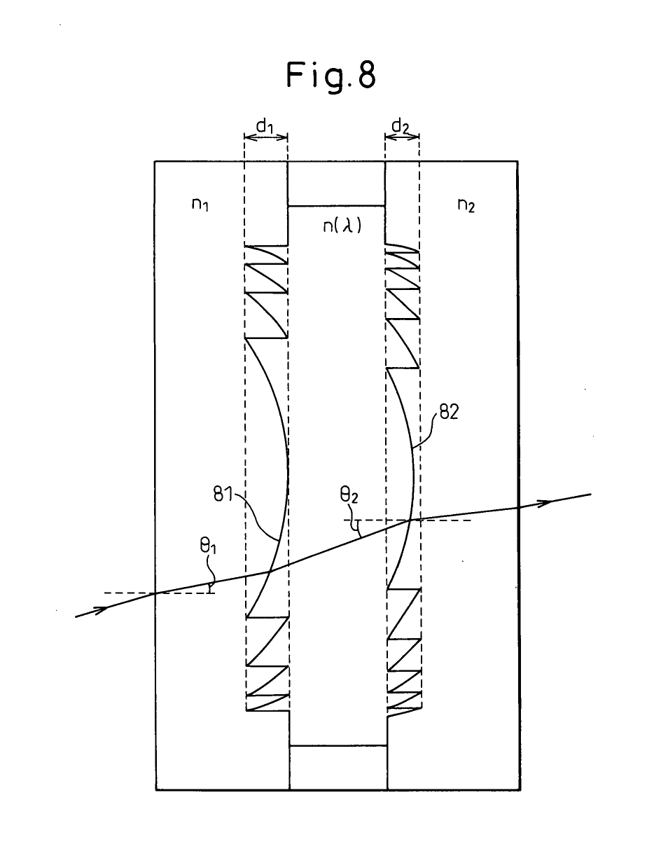

As shown in FIG. 8, when, for example, the diffractive optical surfaces are opposed to each other with a liquid crystal layer sandwiched therebetween, diffractive efficiency ηm (m: order of diffraction) is represented by following equation
ηₘ(λ)=sinc ²{φ(λ)−m}
φ(λ)={n(λ)cos θ₂−n₁(λ)cos θ₁}d₁/λ+{n₂(λ)cos θₘ−n(λ)cos θ₂}d₂/λ (2)
where n₁, represents the refractive index of the substrate for the.first diffractive optical surface 81, and d₁ represents the grating depth of the first diffractive optical surface 81. Similarly, n₂ represents the refractive index of the substrate for the second diffractive optical surface 82, and d₂ represents the grating depth of the second diffractive optical surface 82. λ is the wavelength of the incident light, θ₁ represents the incident angle of the light incident upon the first diffractive optical surface 81, and θ₂ represents the incident angle of the light incident upon the second diffractive optical surface 82. θₘ represents the exit angle of the diffracted light of m-th order (m=1, 2, 3, . . . ). n(λ) represents the refractive index of the liquid crystal layer for wavelength λ. As shown by equation (2), a diffractive optical element that does not depend on the dispersion characteristics of the substrate material nor on incident angle can be designed by optimizing the optical properties of the laminated material and the step difference at the discontinuities of the diffractive optical surfaces 81, 82.

The diffractive efficiency of the step difference at discontinuities in the shape of Fresnel lens surface when a liquid crystal lens is constructed as a laminate type diffractive element will be described below. In the present embodiment, the optical properties of the upper and lower transparent substrates 71, 72 were respectively as follows. Upper substrate: refractive index, 1.55; Abbe number, 56; Lower substrate: refractive index, 1.6; Abbe number, 56. The optical properties of the intermediate liquid crystal layer 75 were: refractive index, 1.5; Abbe number, 30. The shape of a Fresnel lens surface 73 is represented by equation (1), wherein the coefficients are: Q=0.024, B=0.022, D=−0.072. Step was provided each time when the distance from the vertex of Fresnel lens surface 73 along the optical axis was 3.9 μm, such that the position of the lens surface along the optical axis was equal to the position of the vertex. The shape of Fresnel lens surface 74 is also represented by equation (1), wherein the coefficients are: Q=0.049, B=0.044, D=−0.144. The step was provided each time when the distance from the vertex of Fresnel lens surface 74 along the optical axis was 7.8 μm, such that the position of the lens surface along the optical axis was equal to the position of the vertex.

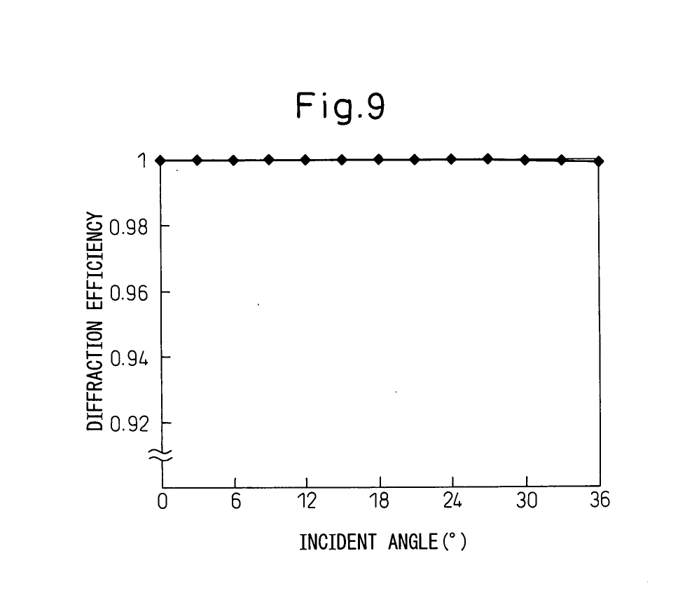

FIG. 9 shows a graph of diffraction efficiency of the above-described laminate type diffraction grating in dependence on the angle of incidence. Values in the graph are shown for spatial frequency of 200 lp/mm. It can be seen from this graph that diffraction efficiency of nearly 100% can be obtained over the useful range of the incident angle by suitable selection of the optical properties of relevant material and step difference at the discontinuities in the shape of Fresnel lens surface.

Thus, a liquid crystal lens having a liquid crystal layer can work as a laminate type diffractive optical element by providing Fresnel lens surface on both sides of the liquid crystal layer and by suitably designing the step difference. When the Fresnel lens surfaces are laminated, by constructing the laminate such that the dependence on the angle of incidence and the dispersion characteristics of respective layers cancel each other, a diffractive element having high diffraction efficiency over the entire range of utilized wavelength and the entire useful range of the incident angle can be obtained.

For example, as in the second embodiment, the step difference of respective Fresnel lens surfaces can be set such that it functions as a diffractive optical element for ordinary ray. In the above embodiment, assuming that the refractive index 1.5 of the liquid crystal layer 75 is the refractive index for ordinary ray, the refractive index of the liquid crystal layer 75 for extraordinary ray can be changed, for example, in the range from 1.65 to 1.72. With such construction, the liquid crystal lens 70 can function as a laminate type diffractive optical element for ordinary ray, and as a Fresnel lens having variable power for extraordinary ray. Alternatively, the step difference of respective Fresnel lens surfaces can be set, as in the first embodiment, such that it functions as a diffractive optical element at the minimum refractive index for extraordinary ray. In this case, unlike the above embodiment, in order to prevent increase of aberration due to interference when the refractive index of the liquid crystal layer 75 for extraordinary ray is changed, it is preferable to select the liquid crystal and material of the transparent substrate such that the liquid crystal layer 75 has higher refractive index than the transparent substrate 71, 72 even when the value of refractive index of the liquid crystal layer 75 for extraordinary ray is minimum.

Even when the liquid crystal lens is constructed as a laminate type diffractive optical element, diffraction efficiency may be deteriorated due to manufacture precision, etc. A laminate type diffractive optical element with Fresnel lens surfaces 73, 74 has a drawback that it is sensitive to error sensitivity. That is, when the manufacture precision is insufficient, a laminate type diffractive optical element may not exhibit desired characteristics. Therefore, in the manufacture of such a diffractive optical element, Fresnel lens surfaces 73, 74 opposed to each other need to be precisely positioned. Thus, in the manufacture of a diffractive optical element, special method has been required for alignment and control of the separation (gap). On the other hand, in the manufacture of a liquid crystal panel, positioning of the upper and lower substrates, and setting of separation of the upper and lower substrates, is carried out in very high precision. For example, a method has been established in which positioning of the upper and lower substrates is carried out by image processing of photographic image obtained with a camera utilizing the alignment mark. Also, a method has been established in which high precision gap control method using a spacer is implemented to determine the separation of the upper and lower substrates in high precision. Therefore, the liquid crystal lens according to the present invention can be manufactured in high precision by using these methods without requiring any additional special process.

Next, the construction of a liquid crystal lens used in an imaging lens device according to still another embodiment of the present invention will be described below.

In the liquid crystal lens according to this embodiment, as in the liquid crystal lens 3 according to the first or the second embodiment, width of the step difference provided on Fresnel lens surface of the liquid crystal lens and useful range of lens power of the liquid crystal lens can be set. The shape of the Fresnel lens surface 3 and the construction of each optical lens can be suitably modified in accordance with the specification.

The liquid crystal lens according to the present embodiment differs from the liquid crystal lens 3 according to the first embodiment in positional relation between the transparent electrodes and Fresnel lens surface. In the liquid crystal lens according to the present embodiment, Fresnel lens surface is disposed on the side of the liquid crystal layers 24a, 24b rather than the transparent electrodes (see FIG. 2). In the case of such positional relation, Fresnel lend surface cannot be formed directly on the transparent electrodes 21, 23. Therefore, a molding method such as injection molding cannot be used for forming Fresnel lens surface. Positional relation between Fresnel lens surface and the electrode and method of forming Fresnel lens surface in the present embodiment and in the first embodiment will be described in further detail below.

For example, when resin material is used as transparent substrate constituting the liquid crystal 3, the transparent substrate having the shape of Fresnel lens surface engraved thereon can be manufactured by injection molding. In this case, the electrode film for driving the liquid crystal can be easily coated on the transparent substrate. With such construction, however, there are two problems.

The first problem, is line breakage of the electrode on the Fresnel lens surface. As shown above, there is a step difference between the zones on the Fresnel lens surface. In order to prevent a line breakage of the electrode film at the step difference, it is required, for example, to increase the thickness of the electrode film or to provide a smooth site on a portion of Fresnel lens surface.

The second problem, is that it is difficult to control the behavior of the liquid crystal molecule near the Fresnel lens surface in accordance with design values. This is because zones and the step between zones of Fresnel lens surface are not parallel to the liquid crystal layer so that a transverse electric field occurs near the Fresnel lens surface by the electrode formed thereon. If the liquid crystal molecules are not oriented in a desired direction due to the transverse electric field, the refractive index of the liquid crystal layer may not change sufficiently.

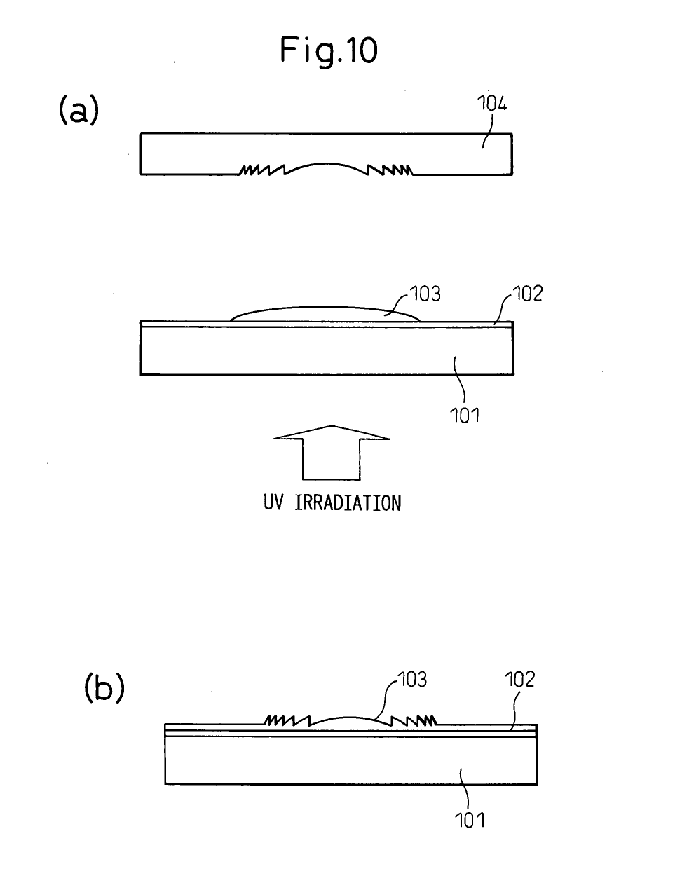

On the contrary, the above-described problem does not occur if the Fresnel lens surface is provided on the electrode. Method of forming such structure will be described below with reference to FIG. 10(a) and FIG. 10(b) as an example. First, as shown in FIG. 10(a), an electrode 102 consisting of transparent electro-conductive film is formed on the transparent substrate 101 by suitable film forming method such as vacuum deposition. Next, liquid UV-curable resin 103 is applied to the surface of the electrode 102, using a suitable coating method such as spin coating. Then, a mold 104 having Fresnel lens surface structure formed thereon is pressed onto the UV-curable resin 103 so as to transfer the shape of the mold 104 to the UV-curable resin 103. Here, UV ray is irradiated from the side of the transparent substrate 101 to thereby harden the UV-curable resin 103. Thus, the Fresnel lens surface is formed on the UV-curable resin 103 applied to the surface of the electrode 102. FIG. 10(b) shows a schematic view of the sectional structure of the formed Fresnel lens surface. Such transfer of mold can be carried out using nano-imprint technology. Material for forming the Fresnel lens surface is not limited to a UV-curable resin. A heat curable resin, for example, may be used as such material.

With the construction as shown in FIG. 10(b), the electrode 102 is formed on the flat plate-shaped transparent substrate 101 so that line breakage of the electrode 102 is unlikely to occur. Since the plane electrode 102 is formed in a plane shape along the transparent substrate 101, uniform electric field can be generated with an electrode provided on a transparent substrate opposed to it with an unshown liquid crystal layer sandwiched therebetween. Therefore, the liquid crystal molecules do not exhibit an anomalous behavior, and the refractive index of the liquid crystal layer can be easily set to the value of specification. In addition, since the electrode 102 is formed before Fresnel lens surface is formed on the transparent substrate 101, deformation of Fresnel lens surface due to temperature rise at the time of formation of the electrode 102 can be prevented.

Since there is a UV-curable resin 103 between the electrode 102 and the liquid crystal layer in the liquid crystal lens according to the present embodiment, a voltage drop is produced due to the resin layer. Thus, in order to apply sufficient electric voltage to the liquid crystal layer for driving the liquid crystal molecule, the driving voltage needs to be higher than that in the liquid crystal lens according to the first embodiment. This increase in the driving voltage, however, is not a problem if the thickness of the UV-curable resin 103 is as small as a few μm to 10 and a few μm.

At the time of molding the UV-curable resin 103, the thickness of the UV-curable resin 103 may become unequal. Alternatively, when a seal member is provided on the UV-curable resin 103, the seal member may sink into the UV-curable resin 103. Therefore, in the construction in which a seal member is provided on the UV- resin 103, it is difficult to manufacture the liquid crystal lens 3 so as to maintain a constant distance between the electrodes sandwiching the liquid crystal layer. Unless the distance between the electrodes is constant, the driving voltage applied to the liquid crystal layer will vary. Variation of the distance between electrodes can be suppressed by removing a part of the layer of UV-curable resin 103 and providing the seal member directly on the electrode 102. Especially when a dielectric constant of the UV-curable resin 103 and dielectric constant of the liquid crystal are equal, the driving voltage can be controlled without being influenced by the variation of thickness of the UV-curable resin 103. In this manner, by suppressing the variation of the distance between the electrodes, the variation of the driving voltage applied to the liquid crystal layer can be suppressed.

It is also possible to use an electro-conductive material as the material for forming a Fresnel lens and to use the electro-conductive material as an electrode. With such a construction, separate electrode film do not need to be provided and the number of layers constituting the liquid crystal lens can be decreased so that adverse effect such as the ghost due to light reflected by the boundary surface between layers can be reduced. Especially, the difference between the refractive index of the material used for the electrode film and the refractive index of the material used for the transparent substrate may sometime become large. In such a case, the reflection from the boundary between the electrode film and the transparent substrate becomes large, and the quality of the image is more adversely influenced than by a transverse electric field produced when a Fresnel lens surface is used as the electrode. Therefore, it is preferable to make the material from which a Fresnel lens is formed to function as an electrode. For example, an electro-conductive polymer can be used as the UV-curable resin 103 from which Fresnel lens is formed. Examples of useful electro-conductive polymer include polyaniline, polypyrrole, polythiophne, polyisothianaphtene, polyethylene dioxythiophene, and the like. In particular, polyethylene dioxythiophene and electro-conductive coating agent based on polyethylene dioxythiophene (for example, CONISOL, available from InsCon Tech (KOREA)) have high electrical conductivity and can be used advantageously as the UV-curable resin 103.

The refractive index or the dispersion value of the resin material used as the UV-curable resin 103 can be controlled, and it is possible to contrive the control so as to achieve matching of the refractive index with the transparent substrate 101 or coincidence with the refractive index of the liquid crystal for ordinary ray. As in the first embodiment, for example, in the case where the liquid crystal lens is caused to function as a diffractive optical element when the refractive index of the liquid crystal layer for extraordinary ray is minimum, it is set so as to coincide with the refractive index of the liquid crystal for ordinary ray. By selecting the resin material in this manner, the liquid crystal lens is in a state of plain glass and has no lens power for the polarization component (ordinary ray) that is orthogonal to the polarization component (extraordinary ray) for which lens power is variable. By setting in this manner, design becomes simple and the liquid crystal lens can be easily designed.

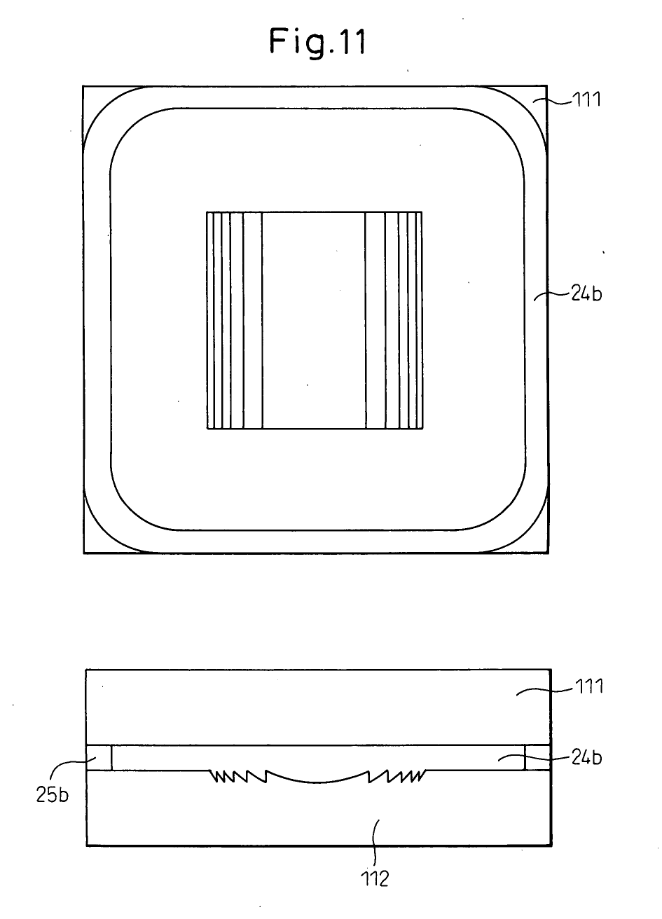

Next, a liquid crystal lens according to still another embodiment of the present invention will be described below with reference to FIG. 11. FIG. 11 shows a schematic plan view and sectional view of a liquid crystal lens according to this embodiment. The liquid crystal lens according to previous embodiments has the structure of Fresnel lens surface in the shape of concentric circles. A liquid crystal lens 3 according to the present embodiment has the structure of Fresnel lens surface in the shape of cylindrical lens. Step difference provided in the cylindrical lens shown here can be set basically in the same manner as the step difference provided on Fresnel lens surface of the liquid crystal lens shown in the first and the second embodiments.

As shown in FIG. 11, the liquid crystal lens according to the present embodiment has the construction in which a transparent substrate 111 and a transparent substrate 112 sandwich a liquid crystal layer 24b therebetween. A Fresnel lens surface in cylindrical shape is formed on the transparent substrate 112. By arranging the transparent substrate 112 having a Fresnel lens surface formed in a cylindrical shape and the transparent substrate having a Fresnel lens surface formed in a similar cylindrical shape such that the respective directions for functioning as a Fresnel lens are orthogonal to each other, and the same function as a general lens can be obtained. In FIG. 11, for the sake of simplicity, only the lower liquid crystal panel is shown, and the upper transparent substrate with Fresnel lens surface and the liquid crystal layer is omitted.

The advantage of such a construction is that Fresnel lens structure divided at each step can be connected at the periphery of the Fresnel lens surface and line breakage of the electrode formed of unshown transparent electro-conductive film can be prevented. In addition, initial orientation of the liquid crystal molecule in the liquid crystal layer of the liquid crystal lens can be accurately determined.

As an orientation processing for determining initial orientation of liquid crystal molecule, a method that uses an oriented film formed by a rubbing process is most widely used. In this method, first, a polyimide based resin is printed on the transparent electrode to form an orientation film. Then, the film is subjected to a burning process, and the orientation film is rubbed in one direction with a rubbing cloth consisting of Rayon, cotton, etc. Liquid crystal molecule is thereby oriented in the direction of grooves formed on the orientation film. When, however, there is a fine structure such as Fresnel lens surface structure, etc., orientation in the portion of the groove of Fresnel lens structure may become insufficient, and may lead to disturbance of the orientation.

Here, when the Fresnel lens surface is not in the shape of circular zones, but has a cylindrical structure, the rubbing process can be easily performed in the direction parallel to the grooves. For the orientation processing in orthogonal direction, it is possible to adopt a process in which rubbing is performed first in the direction parallel to the groove and then orientation direction is modified. As means for modifying the orientation direction, a method using UV irradiation is known. By performing UV irradiation, the orientation direction in the irradiated portion is rotated, and the angle of rotation can be controlled by changing the duration of irradiation. It is possible to rotate the orientation direction as much as 90 degrees.

Orientation processing by oblique deposition works effectively, if it is performed in the direction parallel to the grooves.

In the liquid crystal lens according to each of the embodiments described above, fine structure for orientation may be provided on Fresnel lens surface. For example, a multiplicity of minute grooves having a width of 100 nm or less may be formed on the mold for forming the Fresnel lens surface. This mold may be used for molding the transparent substrate or UV-curable resin on which Fresnel lens surface is to be formed. With such a molding, the orientation processing for forming oriented film can be omitted at the time of manufacturing the liquid crystal lens. Instead of forming minute grooves on the mold for forming a Fresnel lens surface, silicon monoxide (SiO) may be obliquely deposited to form minute structure on the mold for orientation. Further, SiO may be obliquely deposited to a mold having a Fresnel lens surface to be formed so as to obtain a master mold, and the shape of master mold may be transferred to other mold by means of electroforming, glass nano-imprint technique, etc. The mold having the shape of the master mold transferred thereto may be used for molding the transparent substrate or UV-curable resin on which Fresnel lens surface is to be formed.

As has been described above, the imaging lens device according to the present invention is suitable as an imaging lens device for which limitation of size reduction and low profile is highly demanding and very severe, and in addition, high resolution is required, and particularly suitable to be used in a mobile camera phone. The present invention is a technology also applicable to a camera for usual silver salt photography, a digital camera, or a rear vehicle-mounted camera, and the like. The liquid crystal lens described above can be used for a zoom lens, and a zoom lens can be constructed so as to achieve variable power by changing the refractive index of the crystal lens.

The present invention described above is not limited to the above-described embodiment, but various modifications are possible. For example, the dimension which has been described in the first embodiment is simply an example, and the present invention is not limited to these values.

What is claimed is:

1. An imaging lens device comprising:
a liquid crystal lens for focusing an object at a prescribed distance, comprising:
a first liquid crystal layer;
a first transparent substrate disposed adjacent to one surface of said first liquid crystal layer, and having a first electrode and having Fresnel lens surface formed on the boundary with said first liquid crystal layer;
a second transparent substrate disposed adjacent to the other surface of said first liquid crystal layer, and having a second electrode;
wherein, when said first liquid crystal layer has a prescribed refractive index for extraordinary ray incident on said first liquid crystal layer, said Fresnel lens surface functions as a diffractive optical element for said extraordinary ray;
a controller for changing the refractive index of said first liquid crystal layer for extraordinary ray by changing the electric voltage applied between said first electrode and said second electrode; and
an imaging element for taking an image of said object.

2. The imaging lens device according to claim 1, wherein steps are formed on said Fresnel lens surface so as to divide said Fresnel lens surface into a plurality of regions, and wherein optical path difference produced at said step for extraordinary ray incident upon said first liquid crystal layer is an integer multiple of wavelength for which said imaging element has sensitivity when the refractive index of said first liquid crystal layer for extraordinary ray has a prescribed value.

3. The imaging lens device according to claim 1, wherein said first transparent substrate has a member having said Fresnel lens surface formed thereon.

4. The imaging lens device according to claim 3, wherein said first transparent substrate has a flat plate-shaped substrate, said first electrode being disposed between said flat plate-shaped substrate and said member.

5. The imaging lens device according to claim 1, wherein said Fresnel lens surface is formed on a portion of said first transparent substrate.

6. The imaging lens device according to claim 1, wherein said prescribed refractive index is the minimum value of refractive index included in the range of variable refractive index of said first liquid crystal layer for extraordinary ray.

7. The imaging lens device according to claim 1, wherein the refractive index of said first transparent substrate and the refractive index of said first liquid crystal layer for ordinary ray coincide with each other.

8. The imaging lens device according to claim 1, wherein said liquid crystal lens functions as a diffractive optical element for ordinary ray incident upon said first liquid crystal layer.

9. The imaging lens device according to claim 1, wherein said Fresnel lens surface is aspherical surface.

10. The imaging lens device according to claim 1, wherein said second transparent substrate has Fresnel lens surface formed on the boundary with said first liquid crystal layer.

11. The imaging lens device according to claim 1, said liquid crystal lens further comprising:
a second liquid crystal layer;
a third transparent substrate disposed adjacent to one surface of said second liquid crystal layer, and having Fresnel lens surface formed on the boundary with said second liquid crystal layer; and
a fourth transparent substrate disposed adjacent to the other surface of said second liquid crystal layer;
wherein the liquid crystal in said first liquid crystal layer and the liquid crystal in said second liquid crystal layer are oriented with respective long axes orthogonal to each other, and
wherein, when said second liquid crystal layer has a prescribed refractive index for extraordinary ray incident on said second liquid crystal layer, said Fresnel lens surface formed on the boundary with said second liquid crystal layer functions as a diffractive optical element for said extraordinary ray.

12. The imaging lens device according to claim 11, wherein Fresnel lens surface of said first transparent substrate and Fresnel lens surface of said third transparent substrate respectively have the shape of cylindrical lens arranged such that the respective directions for functioning as Fresnel lens are orthogonal to each other.

13. The imaging lens device according to claim 1, wherein said liquid crystal lens is a lens with positive power when it functions as a diffractive optical element.

14. An imaging lens device comprising:
a liquid crystal lens for focusing an object at a prescribed distance, comprising:
a first liquid crystal layer;
a first transparent substrate disposed adjacent to one surface of said first liquid crystal layer, and having a first electrode and having Fresnel lens surface formed on the boundary with said liquid crystal layer; and
a second transparent substrate disposed adjacent to the other surface of said first liquid crystal layer, and having a second electrode;
wherein said Fresnel lens surface functions as a diffractive optical element for ordinary ray incident upon said first liquid crystal layer;
a controller for changing the refractive index of said first liquid crystal layer for extraordinary ray by changing the electric voltage applied between said first electrode and said second electrode; and
an imaging element for taking an image of said object.

15. The imaging lens device according to claim 14, wherein steps are formed on said Fresnel lens surface so as to divide said Fresnel lens surface into a plurality of regions, and wherein optical path difference produced at said step for ordinary ray incident upon said first liquid crystal layer is an integer multiple of wavelength for which said imaging element has sensitivity.

16. The imaging lens device according to claim 15, wherein the optical path difference produced at said step for ordinary ray incident upon said first liquid crystal layer is one or two times said wavelength, and wherein said controller changes the refractive index of said first liquid crystal layer for extraordinary ray such that the minimum value of optical path difference produced at said step for extraordinary ray incident upon said first liquid crystal layer is larger than the coherent length of the extraordinary ray.

17. The imaging lens device according to claim 14, wherein said first transparent substrate has a member having said Fresnel lens surface formed thereon.

18. The imaging lens device according to claim 17, wherein said first transparent substrate has a flat plate-shaped substrate, said first electrode being disposed between said flat plate-shaped substrate and said member.

19. The imaging lens device according to claim 14, wherein said Fresnel lens surface is formed on a portion of said first transparent substrate.

20. The imaging lens device according to claim 14, wherein said Fresnel lens surface is aspherical surface.

21. The imaging lens device according to claim 14, wherein said second transparent substrate has Fresnel lens surface formed on the boundary with said first liquid crystal layer.

22. The imaging lens device according to claim 14, said liquid crystal lens further comprising:
a second liquid crystal layer;
a third transparent substrate disposed adjacent to one surface of said second liquid crystal layer, and having Fresnel lens surface formed on the boundary with said second liquid crystal layer; and
a fourth transparent substrate disposed adjacent to the other surface of said second liquid crystal layer;
wherein the liquid crystal in said first liquid crystal layer and the liquid crystal in said second liquid crystal layer are oriented such that respective long axes are orthogonal to each other, and
wherein said Fresnel lens surface formed on the boundary with said second liquid crystal layer functions as a diffractive optical element for said ordinary ray incident upon said second liquid crystal layer.

23. The imaging lens device according to claim 22, wherein Fresnel lens surface of said first transparent substrate and Fresnel lens surface of said third transparent substrate respectively have the shape of cylindrical lens arranged such that the respective directions for functioning as Fresnel lens are orthogonal to each other.

24. The imaging lens device according to claim 14, wherein said liquid crystal lens is a lens with positive power when it functions as a diffractive optical element.

25. A liquid crystal lens comprising:
a liquid crystal layer;
a first transparent substrate disposed adjacent to one surface of said liquid crystal layer, and having a Fresnel lens surface formed on the boundary with said liquid crystal layer;
a second transparent substrate disposed adjacent to the other surface of said liquid crystal layer; and
a first electrode and a second electrode for changing electric voltage applied to said liquid crystal layer so as to change the refractive index for extraordinary ray incident upon said liquid crystal layer;
wherein, by applying a prescribed electric voltage between said first electrode and said second electrode such that said liquid crystal layer has a prescribed refractive index for extraordinary ray incident on said liquid crystal layer, said Fresnel lens surface functions as a diffractive optical element for said extraordinary ray.

26. A liquid crystal lens comprising:
a liquid crystal layer;
a first transparent substrate disposed adjacent to one surface of said liquid crystal layer, and having a Fresnel lens surface formed on the boundary with said liquid crystal layer;
a second transparent substrate disposed adjacent to the other surface of said liquid crystal layer; and
a first electrode and a second electrode for changing electric voltage applied to said liquid crystal layer so as to change the refractive index for extraordinary ray incident upon said liquid crystal layer;
wherein said Fresnel lens surface functions as a diffractive optical element for an ordinary ray incident upon said liquid crystal layer.
